(19) United States
(12) Patent Application Publication
(10) Pub. No.: US 2008/0204578 A1
(43) Pub. Date: Aug. 28, 2008

(54) Image sensor dark correction method, apparatus, and system

(75) Inventors: Jonathan D. Scheuch, New London, NH (US); Wayne Joseph Tucker, Enfield, NH (US); Dante Pietro D'Amato, Bedford, NH (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: Labsphere, Inc.

(21) Appl. No.: 11/710,653

(22) Filed: Feb. 23, 2007

(51) Int. Cl. H04N 9/64

(52) U.S. Cl. 348/243; 348/E09.037

(57) ABSTRACT

A method of performing dark correction for signals generated by an image sensor is disclosed. Dark state signals are received from an image sensor and a dark correction ratio is determined for each pixel based on the dark state signals. Operational state signals are received from the image sensor and a pseudo dark signal is determined for each pixel based on the dark correction ratio and further based on the operational state signals. A corrected signal value based on the pseudo dark signal is determined. The method is capable of compensating for dark signals from the image sensor over a course of a series of measurements notwithstanding changes in temperature and exposure time.

### BACKGROUND

Solid state image sensors, for example, complementary oxide semiconductor (CMOS) image sensors and charge coupled device (CCD) image sensors, are commonly used as detectors in optical measurement systems, for example, spectrometers—instruments that employ a dispersive optical element, usually a diffraction grating, to separate polychromatic light into its constituent wavelengths and measure the spectral content of the light. Solid state image sensors are comprised of an array of small optical detection elements often referred to as pixels. Solid state image sensors are generally of two types: area image sensors where the pixels are arranged in a two-dimensional array and linear image sensors where the pixels are arranged in a linear array. In spectrometer applications, for example, a solid state linear image sensor is located in the focal plane of an optical system which forms a spectral image of an entrance slit in a dispersive optical element through which light to be analyzed has passed. In this configuration each pixel detects light of a different wavelength. The electronic image read from the image sensor represents a measure of the spectral content of the light being analyzed.

Solid state linear image sensors operate in a charge integration mode in which the signal from a pixel is built up over a defined period of time, commonly referred to as the exposure time or integration time. In operation, light impinging on the pixels creates a charge accumulation in the pixel, commonly referred to as a photo-current, proportional to the light intensity at that location. The pixels generate signals from the photo-current representative of the light intensity for each exposure period. In an ideal solid state image sensor, the pixel signal would only include contributions from the photo-current.

The pixels in solid state image sensors, however, generate current in the absence of light due to the thermal action of electrons in the devices. This thermally generated current is called dark current because it would be present in the image sensor even if the sensor was not being illuminated with light. The dark current adds to the photo-current generated by the pixels when exposed to light, and may vary as a function of the temperature of the image sensor, the exposure time for the pixel during a scan, and among different pixel elements. Therefore, there is a need for improved techniques for correcting dark current in a solid state image sensor.

### SUMMARY

In one embodiment a method of correcting for dark current signals generated by an image sensor comprises receiving dark state signals from an image sensor having an array of pixels. The dark state signals correspond to dark information collected by each pixel. A dark correction ratio is determined for each pixel based on the dark state signals. A corrected signal value is determined for each pixel based on the dark correction ratio for each pixel.

### BRIEF DESCRIPTION OF THE DRAWINGS

FIG. 1 illustrates one embodiment of system.

FIG. 2 illustrates one embodiment of a solid state linear image sensor comprising a linear pixel array.

FIG. 3 is a flow diagram illustrating one embodiment of a method of performing dark correction for signals generated by an image sensor.

FIG. 4 is a flow diagram illustrating one embodiment of a method of performing dark correction for signals generated by an image sensor.

FIG. 5 is a flow diagram illustrating one embodiment of a method of performing dark correction for signals generated by an image sensor.

FIGS. 6A and 6B is a flow diagram illustrating one embodiment of a dark correction method comprising both the first phase and the second phase of performing dark correction for signals generated by an image sensor.

### DESCRIPTION

Before explaining the various embodiments below, it should be noted that the embodiments are not limited in their application or use to the details of construction and arrangement of the elements illustrated in the accompanying drawings and description. These illustrative embodiments may be implemented or incorporated in other embodiments, variations and modifications, and may be practiced or carried out in various ways. Unless otherwise indicated, the terms and expressions employed herein have been chosen for the purpose of describing the illustrative embodiments for the convenience of the reader and thus are not limited in the context in which they are described.

The various embodiments generally relate to image sensors employed in digital cameras, optical scanners and readers, and spectrometers, and techniques for correcting the signal output from the image sensor. The signal output of an image sensor may comprise a dark current noise signal, which contributes to errors in the color-fidelity and resolution of the output image. Accordingly, it is generally desirable to correct the output of a solid state linear image sensor by removing the components of the image sensor signals due to dark current. Various approaches may be employed to reduce the dark current of an image sensor. One technique is to cool the image sensor using liquid nitrogen, for example. This may be accomplished by determining the dark current and the corresponding dark signal, and subtracting the dark signal from the total signal from each pixel in order to gain an accurate measure of the magnitude of the light collected by the pixel. This adjustment is commonly referred to as a dark subtraction or dark correction.

Another technique for determining the dark signal is to measure a sample of image sensors in the factory to determine the average dark current produced by the sensors, and to employ this value for correction. This may not provide a satisfactory solution in most cases because the dark signal is temperature dependent and/or changes with exposure time.

Correction values for digital images may be obtained by using histograms of the images. In these applications, it is assumed a small predetermined percentage of the pixels are black. The next step is to form a histogram of the pixel values and determine the code value that is associated with the predetermined percentage. For example, suppose it is assumed that 2% of all pixels are black and the image being corrected contains 1 Megapixels. This means that 20 Kilopixels in the image are assumed black. Next, all of the pixels in the histogram are added up starting from code value 0 to n to find the last bin for which the sum is less than 20,000. The correction offset is then set to n. Various digital cameras use this method to determine a dark signal correction for a still image prior to any dark correction.

This approach, however, may not be applicable to correct for dark current in a video stream because it would not be stable over time because the value of the offset is determined by an estimate that includes a range of variability. Furthermore, if previously corrected signals are used to determine the offset, the approach would not converge on a reasonable correction because each new application of correction would add to the last, driving the correction to an extreme. This is important because the design of available image sensors often includes a dark level correction that is applied on the image sensor chip before the signal becomes available for the further processing that is required for determining the offset using the histogram method. Moreover, in spectrometer and other spectral measurement applications, the histogram technique is inapplicable because the necessary assumption that a small predetermined percentage of pixels in a scan have no incident light upon them is often false where the solid state image sensor is located in the focal plane of the optical system.

Another technique for determining the dark signal from an image sensor is to mask some of the pixels in the sensor in order to create a blackened-out region of the sensor such that the darkened pixels are incapable of collecting incident light. The signals generated from the darkened pixels are subtracted from the active signals produced by the unmasked, live pixels in the image sensor. However, because the dark signal is a function of both temperature and exposure time, it changes as the operating conditions of the image sensor change. Therefore, the magnitude of the dark signal that must be subtracted from each active signal changes with temperature and exposure time. Recording dark signals frequently during operation would serve to update the dark signals over time and keep them accurate with changing temperature and exposure time. However, frequent recording is both inconvenient and time consuming in an environment where consecutive high speed spectral measurements are being performed, for example, in spectrometer applications.

The value of the dark signals from a solid state image sensor varies among the individual pixels in addition to varying as a function of temperature and exposure time. However, the ratio of the dark signals between any two pixels in a solid state image sensor is a constant value. The various embodiments discussed herein are based on this constant dark signal ratio. The dark correction methods, apparatuses, and systems set forth herein may be employed to compensate for changes in the temperature and exposure time of the image sensor for each individual pixel based on the constant dark signal ratio for each pixel. According to various embodiments, the dark signals for each pixel are only measured and recorded and/or stored one per a predetermined series of measurement scan and used to determine the constant dark ratio for each pixel. The constant dark ratio provides a robust dark correction technique that is useful in correcting for dark signals over the course of a series of measurement scans without recording a dark signal for each pixel in between each scan. Accordingly, the various embodiments described herein provide improved solid state image sensor performance by decreasing dark signal error, while simultaneously decreasing the time between operational scans.

The various embodiments are directed to performing dark correction for signals generated by an image sensor. The various embodiments may be applicable to any solid state image sensor, including CMOS and CCD image sensors in area or linear pixel configurations. Exemplary solid state image sensors may comprise the Kodak KLI-2113 (available from Eastman Kodak Company, Rochester, N.Y. 14650-2010); the NEC μPD3753 (available from NEC Electronics, Kawasaki, Kanagawa, 211-8668, Japan); the Atmel TH7814A (available from Atmel Corporation, San Jose, Calif. 95131); and the Toshiba CIPS308BS621B (available from Toshiba America, Inc., New York, N.Y. 10020). In addition, various embodiments are particularly applicable, but not limited to, the Sony ILX511 2048-pixel CCD linear image sensor available form Sony Electronics, Inc., San Jose, Calif. 95134. The embodiments, however, are not limited in this context.

As used herein, the term “operational state” refers to a condition when light is allowed to impinge incident on an image sensor, such as, for example, during an exposure period of an operational scan collecting light information. The term “dark state” refers to a condition when an image sensor is completely covered, masked, blackened, or darkened, such that light is completely precluded from reaching all of the pixels of the image sensor, such as, for example, during a period when a shutter or equivalent device is closed blocking out incident light/illumination from the entire image sensor.

It may be desirable to have a dark correction technique in which the dark signals are recorded once and remain valid over an extended period of operation. Accordingly, one embodiment is directed to a method of performing dark correction for signals generated by an image sensor wherein dark state signals are received from an image sensor having an array of pixels. The dark state signals correspond to dark information collected by each pixel. The dark correction ratio is determined for each pixel based on the dark state signals. A corrected signal value is determined for each pixel based on the dark correction ratio for each pixel. A corrected signal value is outputted for each pixel.

Another embodiment is directed to a method of performing dark correction for signals generated by an image sensor wherein operational state signals are received from the image sensor. The operational state signals correspond to light information collected by each pixel. A pseudo dark signal is determined for each pixel based on a dark correction ratio for each pixel and further based on the operational state signals. A corrected signal value is determined for each pixel by subtracting the pseudo dark signal for each pixel from the operational state signal for each pixel.

Another embodiment is directed to an apparatus including a module to receive dark state signals from an image sensor comprising an array of pixels wherein the dark state signals correspond to dark information collected by each pixel. The dark correction ratio is determined for each pixel based on the dark state signals. The corrected signal value for each pixel is based on the dark correction ratio for each pixel. The corrected signal value for each pixel is outputted.

Another embodiment is directed to an apparatus including a module to receive operational state signals from an image sensor wherein the operational state signals correspond to light information collected by each pixel. A pseudo dark signal is determined for each pixel based on a dark correction ratio for each pixel and further based on the operational state signals. A corrected signal value is determined for each pixel by subtracting the pseudo dark signal for each pixel from the operational state signal for each pixel.

Another embodiment is directed to a system for sensing light including an optical system, a solid state image sensor, and a signal processing module. The signal processing module is configured to receive dark state signals from an image sensor comprising an array of pixels. The dark state signals correspond to dark information collected by each pixel. A dark correction ratio is determined for each pixel based on the dark state signals. A corrected signal value is determined for each pixel based on the dark correction ratio for each pixel. The corrected signal value for each pixel is outputted.

Another embodiment is directed to a system for sensing light including an optical system, a solid state image sensor, and a signal processing module. The signal processing module is configured to receive operational state signals from an image sensor. The operational state signals correspond to light information collected by each pixel. A pseudo dark signal is determined for each pixel based on a dark correction ratio for each pixel and further based on the operational state signals. A corrected signal value is determined for each pixel by subtracting the pseudo dark signal for each pixel from the operational state signal for each pixel. These and other embodiments are discussed in more detail below with reference to the accompanying figures.

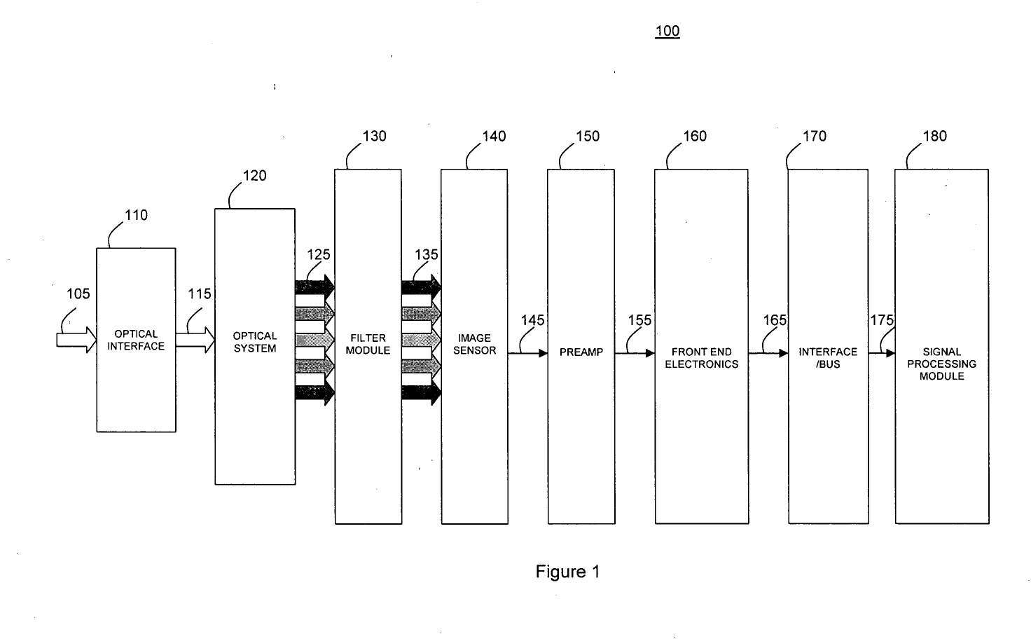

FIG. 1 illustrates one embodiment of system 100. The system 100 includes an optical system 120, a solid state image sensor 140, and a signal processing module 180 configured to implement the methods, processes, and techniques according to various embodiments described herein. It should also be noted that a module for implementing the methods, processes, and techniques according to various embodiments may be configured as part of the front end electronics 160 rather than as a separate signal processing module 180. The system 100 may be any system for sensing light, including, but not limited to spectrometers, digital cameras, scanners of various types, readers of various types, imagers of various types, and any other system including a solid-state image sensor.

In one embodiment, the system 100 may be implemented as a spectrometer comprising an optical interface 110, an optical system 120, a high order filter module 130, a solid state image sensor 140, preamplifier electronics 150, front end electronics 160, an interface 170, and a signal processing module 180. Subject light or illumination 105 to be measured and/or analyzed is incident on the optical interface 110. The subject light 105 passes through the optical interface 110 and light 115 enters the optical system 120. The optical system 120 may comprise any devices or structures known to one of ordinary skill in the art including, but not limited to, lenses of various types, gratings of various types including dispersion gratings, and/or filters of various types. Light 125 exiting the optical system 120 may be separated according to the constituent wavelengths of the incident light 105 and filtered in the filter module 130, which may include any suitable combination and configuration of filter elements known to one of ordinary skill in the art. The light 135 exiting the filter module 130 is incident on the image sensor 140. The optical interface 110, the optical system 120, the filter module 130, and the image sensor 140 may be optically coupled in any suitable manner.

The image sensor 140 produces signals corresponding to dark state signals and operational state signals 145 that are read out by the preamplifier electronics 150. The read signals 155 are sent to the front end electronics 160. The front end electronics 160 may include any suitable combination and configuration of electronic devices, apparatuses, and/or structures known to one of ordinary skill in the art, for example analog to digital conversion systems. Resulting signals 165 (for example a digitized stream of data) are input through the interface 170 and signals 175 are input to the signal processing module 180. The signal processing module 180 may be implemented as or may comprise a dark correction module configured to implement the methods, processes, and techniques according to the various embodiments described herein. The image sensor 140, the preamplifier electronics 150, the front end electronics 160, the interface 170, and the signal processing module 180 are all in electrical communication and may be electrically connected and/or coupled in any suitable manner (e.g., wired or wireless).

The signal processing module 180 may include any suitable apparatus or device configured to effectively implement the various embodiments of the methods, processes, and techniques as described herein, including specifically those described above.

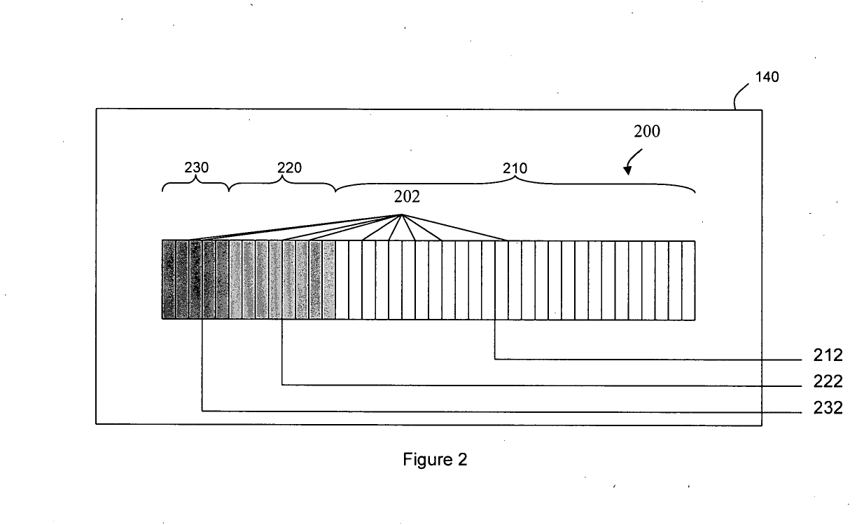

FIG. 2 illustrates one embodiment of the solid state image sensor 140 comprising a linear pixel array 200. The linear pixel array 200 comprises a plurality of pixels 202. FIG. 2 is a top view of the solid state image sensor 140 illustrating different groups of pixels 202 that generate signals that may be subject to dark correction according to various embodiments. The solid state image sensor 140 may be employed in various embodiments. However, the various embodiments are not limited to any particular image sensor or image sensor configuration. As used hereinafter, the term “active pixels” indicates pixels in an image sensor that are open to incident light. In one embodiment, the linear pixel array 200 comprises three groups of pixels 202. A first pixel group 210 comprises live, active pixels that collect light impinging on the pixels during an operational state of the image sensor 140 and create a charge accumulation in the pixel (photo-current) proportional to the light intensity at that pixel. A second pixel group 220 and a third pixel group 230 are physically covered within the image sensor package (i.e., shielded and blackened-out from any light/illumination that may impinge and be incident on the image sensor whether in an operational state or dark state). The third pixel group 230 includes shielded pixels that are inactive pixels. Inactive pixels generate signals that represent and correspond to the electronic offset level for the image sensor 140, referred to hereinafter as “offset pixels”.

First signals 212 from the first pixel group 210 correspond to and are representative of light information collected by each pixel during the operational state, or alternatively, are representative of the dark current in each pixel during the dark state. As used hereinafter, the term “shielded pixels” is intended to indicate pixels in an image sensor that are blocked out from incident light. The second pixel group 220 comprises shielded pixels that are live pixels substantially or completely shielded from incident light. Pixels from the second pixel group 220 are structurally equivalent to the pixels in the first pixel group 210 and are live pixels. One difference being that the pixels in the first pixel group 210 are configured to collect, register, and measure incident light and produce second signals 212 corresponding to light information such as light intensity, for example. The pixels in the second pixel group 220 may not measure incident light and may produce the second signals 222 corresponding to the thermally generated effects without incident light information. Therefore, the second signals 222 represent a direct measure of the dark signal from each of the pixels in the second pixel group 220. The second signals 222 from the pixels in the second pixel group 220 correspond to dark signals from each of the pixels in the second pixel group 220 in both a dark state and an operational state. Accordingly, the second signals 222 from the pixels in the second pixel group 220 comprise components from the electronic offset for the image sensor plus a variable component corresponding to the dark current in the pixels in the second pixel group 220, and third signals 232 from the pixels in the third pixel group 230 may include only the electronic offset component. The third signals 232 from the pixels in the third pixel group 230 are known to have a very steady value that is generally constant regardless of changing image sensor operating conditions.

A dark correction method according to various embodiments involves two phases. The first phase is performed in a dark state and includes the measurement and collection of dark state signals corresponding to dark information from each pixel of the image sensor. The first phase further includes the determination of a dark correction ratio for each of the pixels 202 in the linear array 200. The second phase is performed in an operational state and includes the measurement and collection of operational state signals corresponding to light information from each of the pixels 202 of the image sensor 140. The second phase further includes the determination of a pseudo dark signal value for each of the pixels 202 in the linear array 200.

In various embodiments, the first phase may be performed once (i.e., a single dark scan), for example during initial activation of the image sensor 140 preceding a measurement cycle that may include multiple scans by the image sensor 140. In other embodiments, the first phase may be performed several times preceding a measurement cycle (i.e., a set of predetermined multiple dark scans at a predetermined exposure time, which may be relatively long in order to attain a significant dark state signal magnitude) and the signals from each dark scan collected. The multiple dark state signals corresponding to each pixel 202 can then be averaged for each of the pixels 202 across the multiple dark scans to produce a set of average dark state signals that accurately represents the dark state signal distribution from the image sensor 140. Accordingly, the dark correction ratio can be calculated from dark state signals produced by a single dark scan, or alternatively, from a set of average dark state signals determined from multiple dark scans.

In various embodiments, the second phase may be performed simultaneously with the measurement and collection of operational state signals corresponding to light information from each of the pixels 202 of the image sensor 140 (i.e., with each operational scan). Accordingly, the second phase is performed multiple times over a measurement cycle that may last an extended period of time. For example, the first phase would be repeated after a predetermined period of time (e.g., once or twice per day) in order to recalibrate the dark correction ratio for the image sensor 140. Prior art dark correction techniques generally involve performing a dark scan between each operational scan or whenever exposure time and/or temperature change. Various embodiments address this problem.

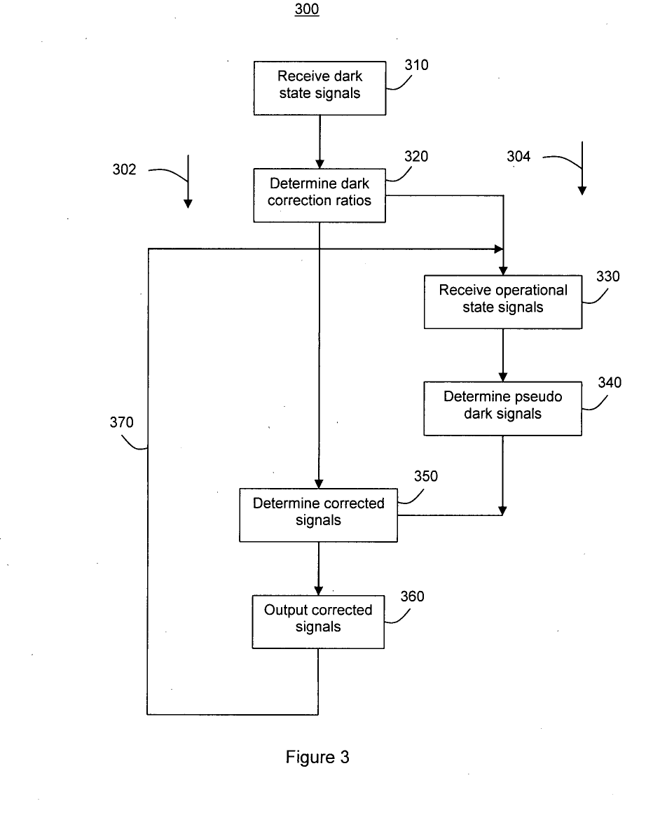

FIG. 3 is a flow diagram 300 illustrating one embodiment of a method of performing dark correction for signals generated by an image sensor. A first phase of the dark correction method is indicated along branch 302 (first phase 302) and a second phase of the dark correction method 300 is indicated along branch 304 (second phase 304). In accordance with the first phase 302 of the dark correction method 300, the signal processing module 180 receives 310 dark state signals from the image sensor 140. The dark state signals correspond to dark information collected by each of the pixels 202 during a dark scan. The dark state signals are employed by the image processing module 180 to determine 320 the dark correction ratio for each of the pixels 202. In various embodiments, the dark correction ratio may be stored in digital memory or by other means (e.g., analog electronic means) and may be employed by the image processing module 180 to determine 350 a corrected signal value for each of the pixels 202 that compensates for the dark current in the respective pixels 202. The image processing module 180 outputs 360 the corrected signal values for each of the pixels 202.

In accordance with the second phase 304, in one embodiment, the image processing module 180 receives 330 the operational state signals from the image sensor 140. The operational state signals correspond to light information measured during an operational scan collected by each of the pixels 202. The image processing module 180 employs the operational state signals to determine 340 a pseudo dark signal for each pixel based on both the operational state signals for each pixel and the dark correction ratio for each pixel. The image processing module 180 determines 350 a corrected signal value for each of the pixels 202 by subtracting the pseudo dark signal for each pixel from the operational state signal for that pixel. The image processing module 180 outputs 360 the corrected signal values for each pixel. The second phase 304 may be repeated 370 with each operational scan.

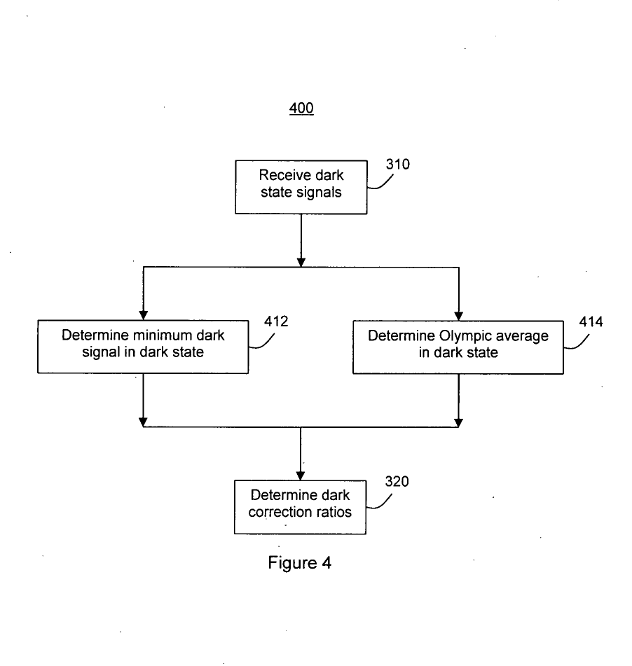

FIG. 4 is a flow diagram 400 illustrating one embodiment of a method of performing dark correction for signals generated by an image sensor. The flow diagram 400 illustrates one embodiment of determining the dark correction ratio for each of the pixels 202 in accordance with block 320 in FIG. 3. Accordingly, the signal processing module 180 receives 310 dark state signals from the image sensor 140 and determines 412 a minimum dark signal from the dark state signals and determines 414 an average from the dark state signals, such as, for example, an Olympic average. As used herein, an Olympic average is calculated for a set of data by eliminating the maximum and minimum values from the set of data and then calculating the average for the remaining values. Other averaging techniques may be used and the embodiments are not limited in this context. In various embodiments, the minimum dark signal is determined as the dark state signal (alternatively, the dark state signal averaged across multiple dark scans) with the minimum magnitude among the dark state signals from each of the pixels 202. In other embodiments, the minimum dark signal is determined by calculating the average of the dark state signals from the pixels in the third pixel group 230 in FIG. 2 corresponding to the electronic offset for the image sensor 140 in the dark state. In various embodiments, the Olympic average is determined by calculating the Olympic average of all of the dark state signals from each of the pixels 202 (alternatively, the Olympic average of the averaged dark state signals across multiple dark scans). In other embodiments, the Olympic average is determined by calculating the Olympic average of the dark state signals corresponding to live, shielded pixels in a blackened-out region of the image sensor 140, i.e., signals corresponding to the pixels in the second pixel group 220 in FIG. 2.

In various embodiments, the dark correction ratio can be calculated for each of the pixels 202 by calculating a first quantity equal to the difference between the dark state signal for each of the pixels 202 and the minimum dark signal determined from the dark state signals, calculating a second quantity equal to the difference between the Olympic average determined from the dark state signals and the minimum dark signal determined from the dark state signals, and dividing the first quantity by the second quantity, i.e., according to the formula:

$${R}_{i} = \frac{{D}_{i} - {M}_{d}}{{A}_{d} - {M}_{d}} \qquad ( Equation 1 )$$

### Where:

Rᵢ=the dark correction ratio for each pixel i based on the dark state signals;

Dᵢ=the dark state signals from each pixel i of the image sensor;

M_{d}=the minimum dark signal determined from the dark state signals; and

A_{d}=the Olympic average determined from the dark state signals.

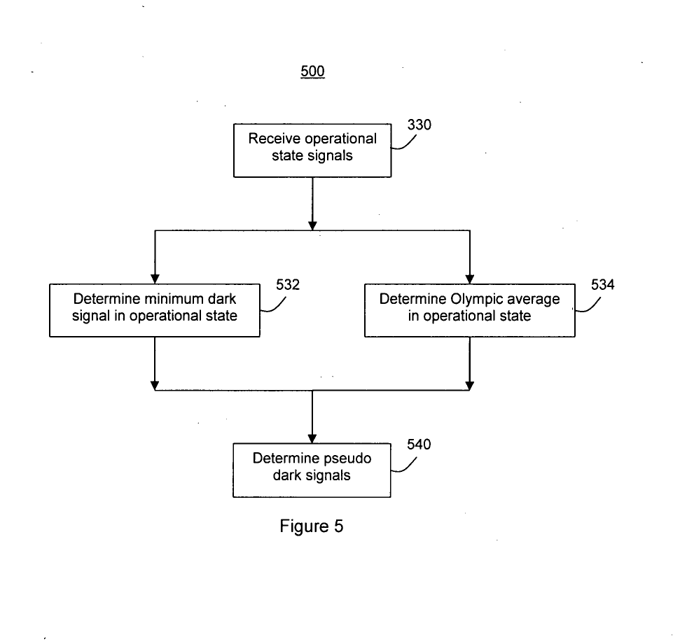

FIG. 5 is a flow diagram 500 illustrating one embodiment of a method of performing dark correction for signals generated by an image sensor. The flow diagram 500 illustrates one embodiment of determining a pseudo dark signal for each of the pixels 202, as determined at block 340 in FIG. 3. Accordingly, the signal processing module 180 receives the operational state signals and determines 532 a minimum dark signal and further determines 534 an Olympic average from the operational state signals. In various embodiments, the minimum dark signal determined from the operational state signals is determined by calculating the average of the operational state signals from the pixels in the third pixel group 230 corresponding to the electronic offset for the image sensor in the operational state. In various embodiments, the Olympic average is determined by calculating the Olympic average of the operational state signals corresponding to live, shielded pixels in a blackened-out region of the image sensor, i.e., signals corresponding to the pixels in the second pixel group 220.

In various embodiments, the pseudo dark signal can be calculated for each of the pixels 202 by calculating a first quantity equal to the product of the dark correction ratio for each of the pixels and the Olympic average determined from the operational state signals, calculating a second quantity equal to the product of the minimum dark signal determined from operational state signals and the quantity 1 (one) minus the dark correction ratio for each pixel, and summing the first quantity and the second quantity, i.e., according to the formula:

Pᵢ=RᵢAₒ+Mₒ(1−Rᵢ) (Equation 2)

### Where:

Pᵢ=the pseudo dark signal for each pixel i;

Rᵢ=the dark correction ratio for each pixel i determined from Equation 1;

Aₒ=the Olympic average determined from the operational state signals; and

Mₒ=the minimum dark signal determined from the operational state signals.

The pseudo dark signal for each of the pixels 202 is a close approximation of the actual dark signal for each of the pixels 202 and can be subtracted from the operational state signal for each active pixel to determine a corrected signal value that can be outputted for subsequent processing.

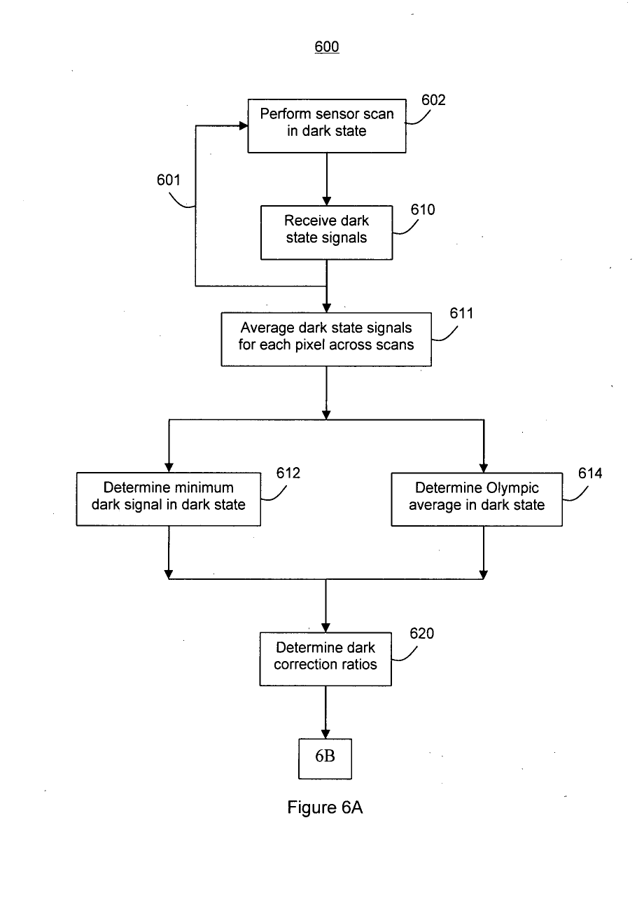

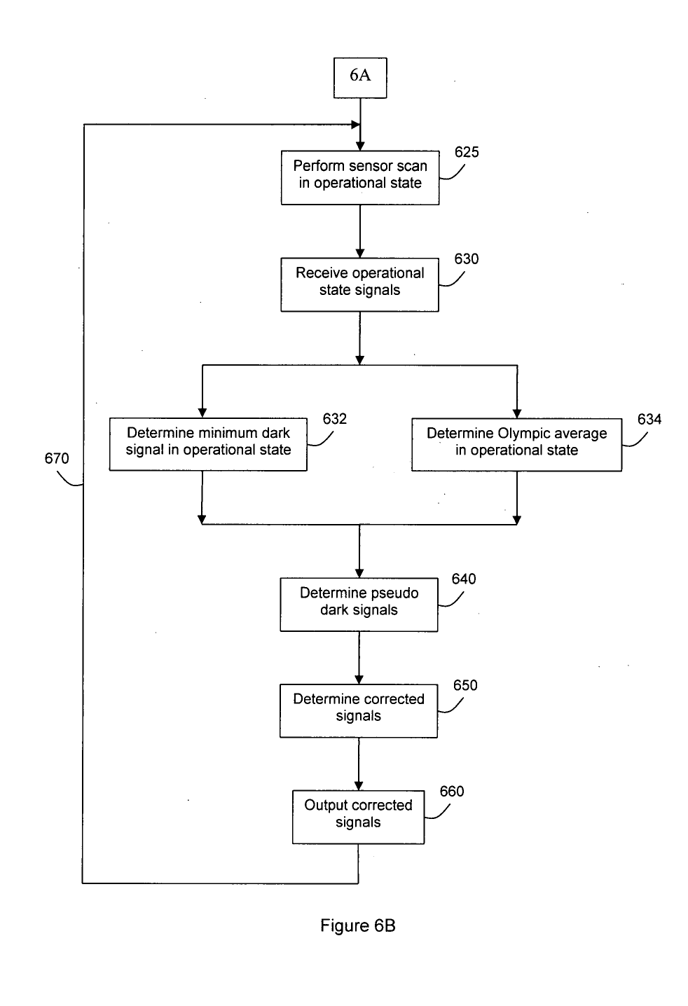

FIGS. 6A and 6B is a flow diagram 600 illustrating one embodiment of a dark correction method comprising both the first phase and the second phase of performing dark correction for signals generated by an image sensor. The flow diagram 600 illustrates one embodiment of a dark correction method comprising both the first phase 302 and the second phase 304 as set forth hereinabove. A dark scan is performed 602 with the image sensor 140 and the resulting signals are received 610 by the signal processing module 180. The image sensor 140 performs 601 additional dark scans for a predetermined number at a predetermined exposure time. The multiple sets of signals generated by each of the pixels 202 during the dark scans are averaged 611 for each pixel across the multiple scan, producing an averaged set of dark state signals for each of the pixels 202 in the image sensor 140. The signal processing module 180 calculates 612 the minimum dark signal and calculates 614 the Olympic average from the averaged dark state signals. The signal processing module 180 determines 620 the dark correction ratio for each pixel is determined according to Equation 1 and stored for later reference.

The image sensor 140 performs 625 an operational scan with the image sensor 140 and the signal processing module 180 receives 630 the resulting signals. The image processing module 180 determines 632 by calculation the minimum dark signal and determines 634 by calculation the Olympic average from the operational state signals. The signal processing module 180 determines 640 the pseudo dark signal for each of the pixels 202 according to Equation 2. The signal processing module 180 determines 650 the corrected signal value for each of the pixels 202 by subtracting the pseudo dark signal for each of the pixels 202 from the operational state signal for each of the pixels 202. The signal processing module 180 outputs 660 the corrected signal value for each of the pixels 202. A subsequent operational scan is performed 670 and the second phase of the process resets. The second phase continues and resets for a number of scans. The number of scans may be predetermined, or alternatively, an undetermined number of operational scans can be performed within a measurement cycle. At the end of the measurement cycle (either due to the performance of a predetermined number of operational scans, the running of a set time interval, or any other criterion), the first phase is performed to in order to recalibrate the dark correction ratio for the image sensor 140.

In various embodiments, the techniques described above are implemented using the signal processing module 180 or a dark correction module portion of the signal processing module 180. The dark correction module can be any suitable apparatus or device configured to effectively implement the various embodiments of the methods, processes, and techniques described hereinabove. For example, and without limitation, suitable devices and apparatuses may include a digital signal processor (DSP), a microprocessor, or other programmable digital electronic device. As used herein, a “processor” or “microprocessor” may be, for example and without limitation, either alone or in combination, a personal computer (PC), server-based computer, main frame, microcomputer, minicomputer, laptop and/or any other computerized device capable of configuration for processing data for standalone applications and/or over a networked medium or media. Processors and microprocessors disclosed herein may include operatively associated memory for storing certain software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, ROM (read only memory), RAM (random access memory), PROM (programmable ROM), EEPROM (extended erasable PROM), and/or other like computer-readable media.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled”, however, also may mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory module. For example, the memory module may include any memory device, memory article, memory medium, storage device, storage article, storage medium and/or storage module, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true scope of the embodiments.

While various embodiments have been shown and described, it should be understood that other modifications, substitutions and alternatives are apparent to one of ordinary skill in the art. Such modifications, substitutions and alternatives are within the scope of the appended claims. Also, it should be understood that the phraseology and terminology used herein is for purpose of description and should not be regarded as limiting.

What is claimed is:

1. A method of performing dark correction for signals generated by an image sensor comprising:
receiving dark state signals from an image sensor comprising an array of pixels, the dark state signals corresponding to dark information collected by each pixel;
determining a dark correction ratio for each pixel based on the dark state signals; and
determining a corrected signal value for each pixel based on the dark correction ratio for each pixel.

2. The method of claim 1, further comprising:
receiving operational state signals from the image sensor, the operational state signals corresponding to light information collected by each pixel;
determining a pseudo dark signal for each pixel based on the dark correction ratio for each pixel and further based on the operational state signals; and
determining a corrected signal value for each pixel by subtracting the pseudo dark signal for each pixel from the operational state signal for each pixel.

3. The method of claim 1, further comprising determining the dark correction ratio for each pixel based on a minimum dark signal determined from the dark state signals and further based on an Olympic average determined from the dark state signals.

4. The method of claim 3, further comprising determining the minimum dark signal by calculating an average of the dark state signals that represent an electronic offset level for the image sensor.

5. The method of claim 3, further comprising determining the Olympic average by calculating the Olympic average of the dark state signals that correspond to live, shielded pixels in a blackened-out region of the image sensor.

6. The method of claim 3, further comprising calculating the dark correction ratio for each pixel by:
calculating a first quantity equal to the difference between the dark state signal for each pixel and the minimum dark signal determined from the dark state signals;
calculating a second quantity equal to the difference between the Olympic average determined from the dark state signals and the minimum dark signal determined from the dark state signals; and
dividing the first quantity by the second quantity.

7. The method of claim 2, further comprising determining the pseudo dark signal for each pixel based on a minimum dark signal determined from the operational state signals and further based on an Olympic average determined from the operational state signals.

8. The method of claim 7, further comprising determining the minimum dark signal by calculating the average of the operational state signals that represent an electronic offset level for the image sensor.

9. The method of claim 7, further comprising determining the Olympic average by calculating the Olympic average of the operational state signals that correspond to active pixels in a blackened-out region of the image sensor.

10. The method of claim 7, further comprising calculating the pseudo dark signal by:
calculating a first quantity equal to the product of the dark correction ratio for each pixel and the Olympic average determined from the operational state signals;
calculating a second quantity equal to the product of the minimum dark signal determined from operational state signals and the quantity 1 minus the dark correction ratio for each pixel; and
summing the first quantity and the second quantity.

11. An apparatus for performing dark correction for signals generated by an image sensor, the apparatus comprising:
a module to receive dark state signals from an image sensor comprising an array of pixels, the dark state signals corresponding to dark information collected by each pixel; determine a dark correction ratio for each pixel based on the dark state signals; and determine a corrected signal value for each pixel based on the dark correction ratio for each pixel.

12. The apparatus of claim 11, wherein the module is to receive operational state signals from the image sensor, the operational state signals corresponding to light information collected by each pixel; determine a pseudo dark signal for each pixel based on the dark correction ratio for each pixel and further based on the operational state signals; and determine a corrected signal value for each pixel by subtracting the pseudo dark signal for each pixel from the operational state signal for each pixel.

13. The apparatus of claim 11, wherein the module is to determine the dark correction ratio for each pixel based on a minimum state signal determined from the dark state signals and further based on an Olympic average determined from the dark state signals.

14. The apparatus of claim 13, wherein the module is to determine calculate an average of the dark state signals that represent an electronic offset level for the image sensor.

15. The apparatus of claim 13, wherein the module is to determine the Olympic average by calculating the Olympic average of the dark state signals that correspond to live, shielded pixels in a blackened-out region of the image sensor.

16. The apparatus of claim 13, wherein the module is to calculate a first quantity equal to the difference between the dark state signal for each pixel and the minimum dark signal determined from the dark state signals; calculate a second quantity equal to the difference between the Olympic average determined from the dark state signals and the minimum dark signal determined from the dark state signals; and divide the first quantity by the second quantity.

17. The apparatus of claim 12, wherein the module is to determine the pseudo dark signal for each pixel based on a minimum dark signal determined from the operational state signals and further based on an Olympic average determined from the operational state signals.

18. The apparatus of claim 17, wherein the module is to determine the minimum dark signal by calculating the average of the operational state signals that represent an electronic offset level for the image sensor.

19. The apparatus of claim 17, wherein the module is to determine the Olympic average by calculating the Olympic average of the operational state signals that correspond to active pixels in a blackened-out region of the image sensor.

20. The apparatus of claim 17, wherein the module is to calculate a first quantity equal to the product of the dark correction ratio for each pixel and the Olympic average determined from the operational state signals; calculate a second quantity equal to the product of the minimum dark signal determined from operational state signals and the quantity 1 minus the dark correction ratio for each pixel; and sum the first quantity and the second quantity.

21. A system, comprising:
a solid state image sensor; and
a signal processing module to receive dark state signals from an image sensor comprising an array of pixels, the dark state signals corresponding to dark information collected by each pixel; determine a dark correction ratio for each pixel based on the dark state signals; and determine a corrected signal value for each pixel based on the dark correction ratio for each pixel.

22. The system of claim 21, wherein the signal processing module is to receive operational state signals from the image sensor, the operational state signals corresponding to light information collected by each pixel; determine a pseudo dark signal for each pixel based on the dark correction ratio for each pixel and further based on the operational state signals; and determine a corrected signal value for each pixel by subtracting the pseudo dark signal for each pixel from the operational state signal for each pixel.

23. The system of claim 21, wherein the signal processing module is to determine the dark correction ratio for each pixel based on a minimum state signal determined from the dark state signals and further based on an Olympic average determined from the dark state signals.

24. The system of claim 23, wherein the signal processing module is to determine the minimum dark signal by calculating an average of the dark state signals that represent an electronic offset level for the image sensor.

25. The system of claim 23, wherein the signal processing module is to determine the Olympic average by calculating the Olympic average of the dark state signals that correspond to live, shielded pixels in a blackened-out region of the image sensor.

26. The system of claim 23, wherein the signal processing module is to calculate a first quantity equal to the difference between the dark state signal for each pixel and the minimum dark signal determined from the dark state signals; calculate a second quantity equal to the difference between the Olympic average determined from the dark state signals and the minimum dark signal determined from the dark state signals; and divide the first quantity by the second quantity.

27. The system of claim 22, wherein the signal processing module is to determine the pseudo dark signal for each pixel based on a minimum dark signal determined from the operational state signals and further based on an Olympic average determined from the operational state signals.

28. The system of claim 27, wherein the signal processing module is to determine the minimum dark signal by calculating the average of the operational state signals that represent an electronic offset level for the image sensor.

29. The system of claim 27, wherein the signal processing module is to determine the Olympic average by calculating the Olympic average of the operational state signals that correspond to active pixels in a blackened-out region of the image sensor.

30. The system of claim 27, wherein the signal processing module is to calculate a first quantity equal to the product of the dark correction ratio for each pixel and the Olympic average determined from the operational state signals; calculate a second quantity equal to the product of the minimum dark signal determined from operational state signals and the quantity 1 minus the dark correction ratio for each pixel; and sum the first quantity and the second quantity.
